(19) United States
(12) Patent Application Publication
(10) Pub. No.: US 2025/0078123 A1
(43) Pub. Date: Mar. 6, 2025

(54) SERVICE PLAN GENERATION SYSTEM AND METHOD THEREOF

(71) Applicants: INVENTEC (PUDONG) TECHNOLOGY CORPORATION, Shanghai (CN); INVENTEC CORPORATION, Taipei City (TW)

(72) Inventors: Yu-Lun CHANG, Taipei City (TW); Jing-Lun HUANG, Taipei City (TW); Chih-Fan HSU, Taipei City (TW); Wei-Chao CHEN, Taipei City (TW)

(73) Assignees: INVENTEC (PUDONG) TECHNOLOGY CORPORATION, Shanghai (CN); INVENTEC CORPORATION, Taipei City (TW)

(21) Appl. No.: 18/409,611

(22) Filed: Jan. 10, 2024

(30) Foreign Application Priority Data
Aug. 30, 2023 (CN) 202311113408.5

(51) Int. Cl. G06Q 30/0283

(52) U.S. Cl. CPC G06Q 30/0283

(57) ABSTRACT

A service plan generation method performed by a computing device includes: receiving a service request, wherein the service request includes a plurality of feature labels; selecting a plurality of recommended items from an item database according to the plurality of feature labels; calculating a plurality of item failure rates according to a plurality of historical execution records of the plurality of recommended items; calculating a plurality of redo counts corresponding to the plurality of recommended items according to the plurality of item failure rates; generating a plurality of buffer items corresponding to the plurality of recommended items according to the plurality of redo counts; and performing a scheduling according to the plurality of recommended items and the plurality of buffer items to generate a service plan.

### CROSS-REFERENCE TO RELATED APPLICATIONS

This non-provisional application claims priority under 35 U.S.C. § 119 (a) on Patent Application No(s). 202311113408.5 filed in China on Aug. 30, 2023, the entire contents of which are hereby incorporated by reference.

### BACKGROUND

### 1. Technical Field

The present disclosure relates to request for quotation, and more particular to a service plan generation system and method thereof.

### 2. Related Art

A Request for Quotation (RFQ) requests for services such as design, production, or testing. A service plan will then be created as the common ground for reviewing the cost of resources including but not limited to labor, equipment, material, and environment. The RFQ process is the business core, as a service plan quotation needs to be reliable and reasonable to the client, but also should be profitable for the service provider. The pain points are as follows:

First, time consuming: It is manually translated from business requirements into technical service items by various function teams, and then scheduled accordingly. This is very time-consuming as it requires many parties being looped in the discussion, which increases the complexity, and takes a long time to respond to the clients.

Second, inaccurate cost estimation: Normally the cost could be more than expected because chances are some of the service items cannot be delivered to the client smoothly as expected and require “redo” to secure the quality of service. Currently it is considered by adding a simple “risk coefficient” that times the ideal (no-failure) cost to ensure that the service plan is still profitable. However, simple coefficient tends to be safe, so the pricing is much higher which leads to business opportunity loss in the bidding process, and during negotiation, the tradeoffs between higher cost or higher risk are quantitatively unknown.

### SUMMARY

In light of the above descriptions, the present disclosure provides a service plan generation system and method thereof that can generate a service plan quotation automatically, limiting it to the least human effort, which saves time and cost.

According to one or more embodiments of the present disclosure, a service plan generation method performed by a computing device includes: receiving a service request, wherein the service request includes a plurality of feature labels; selecting a plurality of recommended items from an item database according to the plurality of feature labels; calculating a plurality of item failure rates according to a plurality of historical execution records of the plurality of recommended items; calculating a plurality of redo counts corresponding to the plurality of recommended items according to the plurality of item failure rates; generating a plurality of buffer items corresponding to the plurality of recommended items according to the plurality of redo counts; and performing a scheduling according to the plurality of recommended items and the plurality of buffer items to generate a service plan.

According to one or more embodiments of the present disclosure, a service plan generation system includes an item database, an item selector, a failure rate calculator and a service scheduler. The item database is configured to store a plurality of standardized items. The item selector is configured to select a plurality of recommended items from the plurality of standardized items of the item database according to a plurality of feature labels included in a service request. The failure rate calculator is configured to calculate a plurality of item failure rates according to a plurality of historical execution records of the plurality of recommended items, calculate a plurality of redo counts corresponding to the plurality of recommended items according to the plurality of item failure rates, and generate a plurality of buffer items corresponding to the plurality of recommended items according to the plurality of redo counts. The service scheduler is configured to perform a scheduling according to the plurality of recommended items and the plurality of buffer items to generate a service plan.

In view of the above, the present disclosure introduces a service plan generation system and method for automatically generating service plan quotations, minimizing human intervention, thus saving time and costs. The service plan quotation includes a list of work items, a schedule of service item execution, and cost estimations. Clients send requests containing project information or criteria through terminal devices, and the system reviews historical execution records to provide a recommended list of service items, estimates the item execution duration, and considers the risk of failure. Subsequently, schedules and cost estimations can be generated and sent back to the client's device. The advantages of the present disclosure are as follows. First, time-saving, the above process is not only digitized but also automated, saving time and increasing service flexibility. Second, transparent and adjustable cost estimation, cost components can be tracked from the itemized historical execution records, and it can also display the service confidence level for this plan. For business negotiations, the proposed costs can still be adjusted to fit the client's budget, and the selected service confidence level can reflect the risk of this plan.

The aforementioned context of the present disclosure and the detailed description given herein below are used to demonstrate and explain the concept and the spirit of the present application and provides the further explanation of the claim of the present application.

### BRIEF DESCRIPTION OF THE DRAWINGS

The present disclosure will become more fully understood from the detailed description given hereinbelow and the accompanying drawings which are given by way of illustration only and thus are not limitative of the present disclosure and wherein:

FIG. 1 is an architectural diagram of a service plan generation system according to an embodiment of the present disclosure;

FIG. 2 is a schematic diagram of recommended items and buffer items; and

FIG. 3 is a flowchart of a service plan generation method according to an embodiment of the present disclosure.

### DETAILED DESCRIPTION

In the following detailed description, for purposes of explanation, numerous specific details are set forth in order to provide a thorough understanding of the disclosed embodiments. According to the description, claims and the drawings disclosed in the specification, one skilled in the art may easily understand the concepts and features of the present disclosure. The following embodiments further illustrate various aspects of the present disclosure, but are not meant to limit the scope of the present disclosure.

The present disclosure provides a service plan generation system implemented as software executed by a computing device. In an embodiment, the computing device can be implemented in one or more of the following examples: personal computer, network server, microcontroller (MCU), application processor (AP), field-programmable gate array (FPGA), Application-Specific Integrated Circuit (ASIC), system-on-a-chip (SOC), deep learning accelerator, or any electronic device with similar functionality. The present disclosure does not limit the hardware type of the computing device. Additionally, the present disclosure does not limit the number of computing devices. For example, each module in the software can be executed on separate computing devices, and multiple computing devices can communicate with each other.

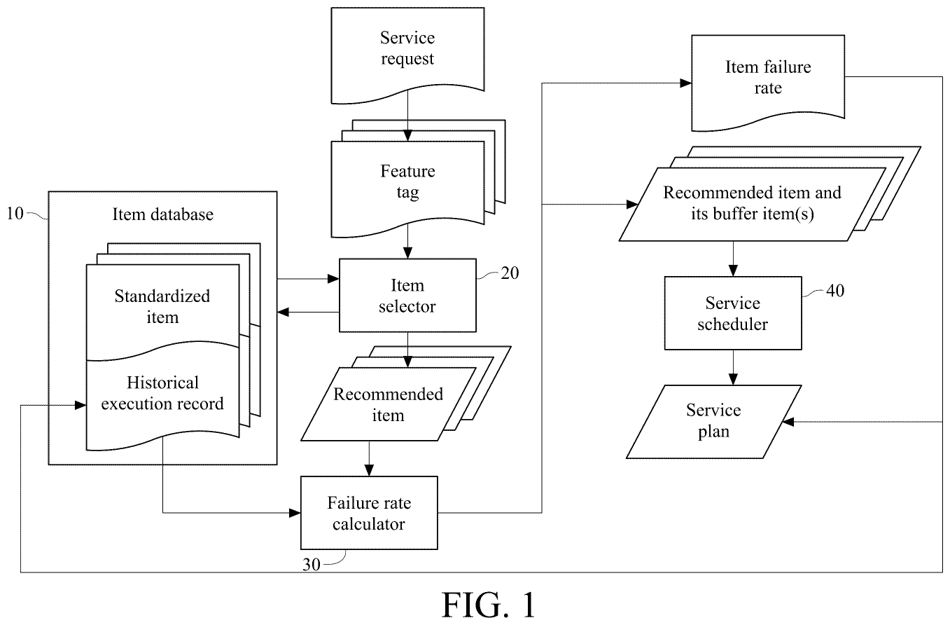

FIG. 1 is an architectural diagram of a service plan generation system according to an embodiment of the present disclosure. As shown in FIG. 1, the service plan generation system includes an item database 10, an item selector 20, a failure rate calculator 30, and a service scheduler 40.

The item database 10 is configured to store a plurality of standardized items. In an embodiment, each standardized item includes information such as service name, execution steps, required time/materials/cost for the service, and relevance to other services, but is not limited to the examples mentioned above. In an embodiment, a service provider generates the plurality of standardized items and a feature label set according to a plurality of historical execution records of a plurality of services. The detail of the generation method is described later.

The item selector 20 selects a plurality of recommended items from a plurality of standardized items in the item database 10 according to a plurality of feature labels included in a service request.

In an embodiment, the service request is a contract or a document. The item selector 20 can apply natural language processing (NLP) techniques to analyze the text of the service request for selecting feature labels. In another embodiment, the customer or service provider selects feature labels relevant to the service request from a set of feature labels provided by the system and inputs them to the item selector 20. In yet another embodiment, text data of the service request is inputted into an artificial intelligence chatbot program (such as ChatGPT), and the response text from this program is broken down into a plurality of phrases to match relevant feature labels from the item database 10.

An example of the service request is as follows: “objective: a birthday party for a 10-year-old girl who likes the strawberry, with around 20 children (age from 8-10 year-old) and their parents, no peanuts and chocolate due to allergy issue”. An example of a feature label set is shown in Table 1 below, and examples of standardized items and recommended items are shown in Table 2 below.

Table 1, example of standardized items

| Set No. | Tag No. | Feature tag | Candidate tag |
|---|---|---|---|
| 1 | 1 | banana | |
| | 2 | blueberry | Yes |
| | 3 | cherry | |
| | 4 | chocolate | No |
| | 5 | strawberry | Yes |
| 2 | 1 | pound | |
| | 2 | birthday | Yes |

Table 2, example of standardized items and recommended items

| No. | Standardized item | Recommended item |
|---|---|---|
| 1 | ice cream | |
| 2 | cake | Yes |
| 3 | milkshake | |
| . . . | . . . | . . . |

The failure rate calculator 30 is configured to calculate a plurality of item failure rates according to a plurality of historical execution records of the plurality of recommended items, calculate a plurality of redo counts corresponding to the plurality of recommended items according to the plurality of item failure rates, and generate a plurality of buffer items corresponding to the plurality of recommended items according to the plurality of redo counts.

In an embodiment, the failure rate calculator 30 calculates the item failure rate based on Bayesian Inference as the following Equation 1:

$${F}_{adjusted} = \frac{{N}_{conf} \times {F}_{prior} + {N}_{item} \times {F}_{item}}{{N}_{conf} + {N}_{item}} \qquad ( Equation 1 )$$

where F_{adjusted} is the item failure rate, which is the weighted sum of Fₚᵣᵢₒᵣ and Fᵢₜₑₘ. Fₚᵣᵢₒᵣ is an intrinsic failure rate of each standardized item in the item database 10. Its default value is, for example, the average item failure rate for all standardized items in the item database 10. Fᵢₜₑₘ is an average historical failure rate of the recommended item. Nᵢₜₑₘ is the number of historical executions of the recommended item. N_{conf} is a constant representing the number of executions required for each standardized item to gain confidence before being considered. Its default value is, for example the average number of executions for all standardized items in the item database 10.

In an embodiment, the failure rate calculator 30 uses the following Equation 2 to calculate the redo count N_{redo} for each recommended item:

$${N}_{redo} = \frac{{N}_{Failure}}{{N}_{Success}} = \frac{{F}_{adjusted}}{1 - {F}_{adjusted}} \qquad ( Equation 2 )$$

where N_{Failure} is the sum of failure occurrences of the recommended item itself and the average failure occurrences of standardized items, and N_{Success} is the sum of success occurrences of the recommended item itself and the average success occurrences of standardized items.

An example of recommended items along with their failure rates and redo counts is shown in Table 3 below.

Table 3, example of recommended items with failure rates and redo counts

| | | | | | | Item | Expected | Quantized |
|---|---|---|---|---|---|---|---|---|
| Recom. | | | | | | execution | redo | redo |
| item | Instance | Std. items | Fᵢₜₑₘ | Fₚᵣᵢₒᵣ | F_{adjusted} | time | count | count |
| 1 | 8 | Strawberry | 0.0000 | 0.1097 | 0.0822 | 10 | 0.0896 | 0 |
| | | Birthday | | | | | | |
| | | Cake | | | | | | |
| 2 | . . . | . . . | 0.9285 | 0.1097 | 0.6829 | 10 | 2.1537 | 2 |
| 3 | . . . | . . . | 0.9000 | 0.5000 | 0.8076 | 20 | 4.2000 | 4 |
| 4 | . . . | . . . | . . . | . . . | . . . | . . . | . . . | . . . |
| 5 | . . . | . . . | . . . | . . . | . . . | . . . | . . . | . . . |
| 6 | . . . | . . . | . . . | . . . | . . . | . . . | . . . | . . . |
| 7 | . . . | . . . | 0.6538 | 0.1097 | 0.5518 | 60 | 1.2312 | 1 |
| 8 | 101 | Fruit | 0.3750 | 0.1097 | 0.3219 | 60 | 0.4748 | 1 |
| | | Cheesecake | | | | | | |
| 9 | 11 | Vanilla | 0.2379 | 0.5000 | 0.2474 | 60 | 0.3287 | |
| | | Milkshake | | | | | | |
| 10 | 35 | Egg | 1.0000 | 0.1097 | 0.3322 | 60 | 0.4976 | |
| | | Pudding | | | | | | |

In Table 3, the recommended items are sorted based on the execution time of the recommended items, arranged from smallest to largest.

As shown in Table 3, the expected redo count calculated according to Equation 2 is a floating-point number, but the actual number of executions of an item can only be an integer. Therefore, the failure rate calculator 30 is configured to convert the fraction part of each expected redo count into an integer according to a quantization threshold. For example, a quantization threshold of 0.5 is used in Table 3, meaning rounding to the nearest integer, resulting in quantized redo counts.

As shown in Table 3, if the expected redo count for a recommended item is greater than 1, its quantized redo count will necessarily be greater than 1. If the expected redo count for a recommended item is less than 1 and less than the quantization threshold, its quantized redo count will be 0. However, for a plurality of recommended items with the same execution time, such as item 8, item 9, and item 10, although their individual expected redo counts are all less than 1, the sum of their expected redo counts is greater than 1 (0.4748+0.3287+0.4976=1.3011>1). Therefore, it is necessary to add an extra redo count for these three recommended items to account for the possibility of any one of them failing.

In an embodiment, after calculating the plurality of item failure rates, the failure rate calculator 30 is configured to compare an overall failure rate threshold with each of the plurality of item failure rates to filter the plurality of recommended items. In the example of Table 3, when the overall failure rate threshold is set to 0.4, recommended items 1, 8, 9, and 10 may be excluded. Whether to exclude recommended items higher or lower than the overall failure rate threshold depends on the content of the service request. For example, in the case of hardware failure testing, it is important to retain items with higher failure rates to ensure that faulty hardware can be detected.

In an embodiment, after calculating the plurality of item failure rates, the failure rate calculator 30 can write these item failure rates back into the historical execution records, thereby updating Fᵢₜₑₘ, the average historical failure rate of each standardized item. The service providers can also manually adjust the Fₚᵣᵢₒᵣ value of a standardized item based on the most recent item failure rate.

In an embodiment, the service plan generation system precomputes the item failure rates of all standardized items in the item database 10 to quickly respond to computational demands brought by service requests. In another embodiment, when the service plan generation system accumulates K service requests, it recalculates the item failure rates for all current recommended items and updates them in the item database 10, where K is greater than or equal to 1, without limitation by the present disclosure.

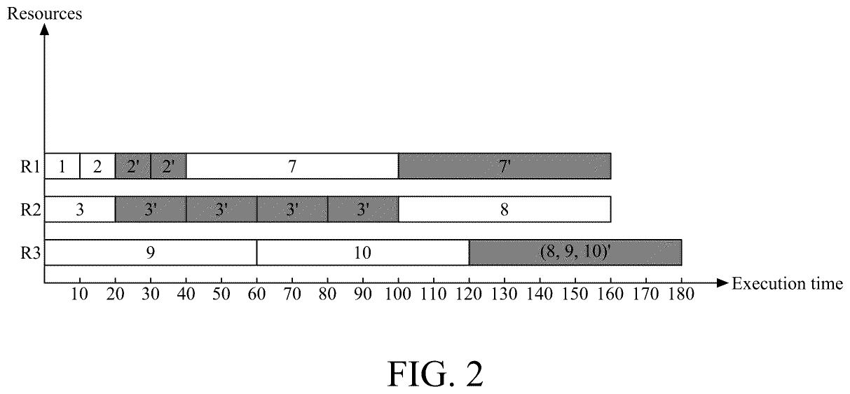

After the failure rate calculator 30 calculates the quantized redo counts, it can generate a plurality of buffer items corresponding to each recommended item. Based on the numerical example in Table 3, FIG. 2 is a schematic diagram of recommended items and buffer items. As shown in FIG. 2, recommended items that use the same resources are arranged in the same row. For example, recommended items 1, 2, and 7 use resource R1 during execution, recommended items 3 and 8 use resource R2 during execution, and recommended items 9 and 10 use resource R3 during execution. In FIG. 2, the execution periods of buffer items are scheduled after the corresponding recommended items. For example, the quantized redo count of recommended item 3 is 4, therefore, recommended item 3 is scheduled from time 0 to 20, followed by 4 consecutive buffer items 3′ scheduled from time 20 to 100. Additionally, buffer items labeled (8, 9, 10)′ in FIG. 2 represent a combined buffer item shared by recommended items 8, 9, and 10.

The service scheduler 40 is configured to schedule a service plan according to all recommended items and buffer items, taking into account the resource requirements, execution times, and execution costs of each item, in order to present the total execution time and total cost in the final output service plan. In practice, the service scheduler 40 can use existing scheduling software, such as Siemens Opcenter APS, to perform scheduling optimization and output Gantt charts. Furthermore, FIG. 2 can be considered as one scheduling result of the service scheduler 40 (items 4 to 6 are for illustration purposes only and are not shown in FIG. 2.

In an embodiment, after calculating the plurality of item failure rates, the failure rate calculator 30 is further configured to calculate a confidence level of the service plan, which is the ratio of the cumulative quantized redo time to the cumulative expected redo time. The calculation of the confidence level is illustrated in Table 4 below.

Table 4, example of confidence level calculation

| Recom. | | Expected | Expected | Quantized | Quantized | Cumulative | Cumulative |
|---|---|---|---|---|---|---|---|
| Item | Exe. | Redo | Redo | Redo | Redo | Expected | Quantized |
| No. | Time | Count | Time | Count | Time | Redo Time | Redo Time |
| 1 | 10 | 0.0896 | 0.8960 | 0 | 0 | 0.90 | 0 |
| 2 | 10 | 2.1537 | 21.5370 | 2 | 20 | 22.43 | 20 |
| 3 | 20 | 4.2000 | 84.0000 | 4 | 80 | 106.43 | 100 |
| 4 | . . . | . . . | . . . | . . . | . . . | . . . | . . . |
| 5 | . . . | . . . | . . . | . . . | . . . | . . . | . . . |
| 6 | . . . | . . . | . . . | . . . | . . . | . . . | . . . |
| 7 | 60 | 1.2312 | 73.8720 | 1 | 60 | 180.31 | 160 |
| 8 | 60 | 0.4748 | 28.4880 | 1 | 60 | 208.80 | 220 |
| 9 | 60 | 0.3287 | 19.7220 | | | 228.52 | |
| 10 | 60 | 0.4976 | 29.8560 | | | 258.38 | |

In Table 4, columns such as item execution time, expected redo count, and quantized redo count follow the examples from Table 3. The expected redo time is the product of item execution time and expected redo count (e.g., 20×4.2000=84.0000). The quantized redo time is the product of item execution time and quantized redo count (e.g., 20×4=80). The cumulative expected redo time is the total expected redo time from the first entry 1 to the current entry (e.g., 0.8960+21.5370+84.0000≈106.43). The cumulative quantized redo time is the total quantized redo time from the first entry to the current entry (e.g., 2+40+80=100). Therefore, for a service plan including recommended items 1 to 10, the confidence level is 250/258.38=0.85. The numerical value of the confidence level provides service providers with more room for discussion during negotiations with clients. For example, it can be used to persuade clients to increase service costs, inform them of the risk of extended service schedules, or modify service items to meet specified cost requirements in a service request.

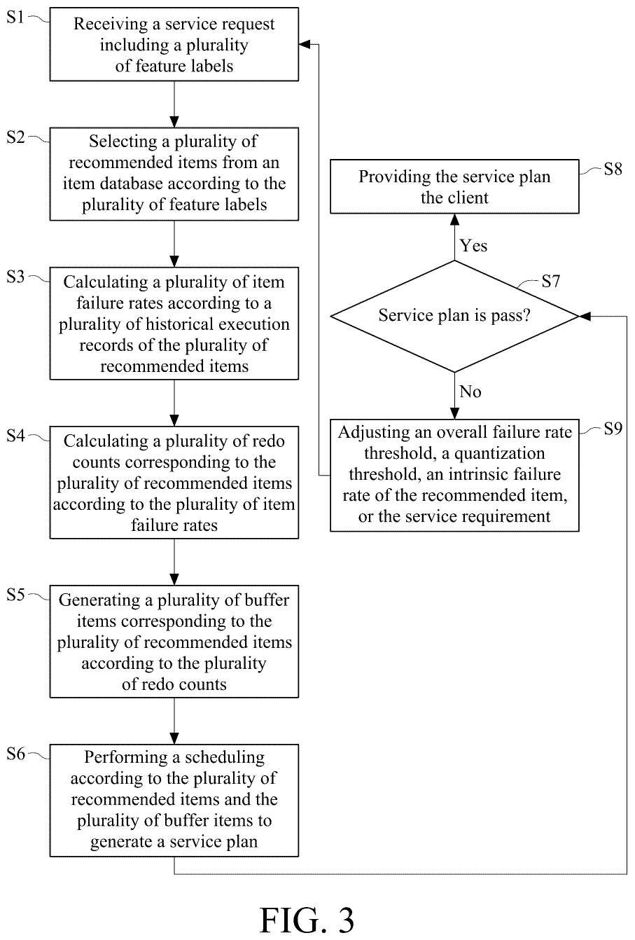

FIG. 3 is a flowchart of a service plan generation method according to an embodiment of the present disclosure. The method is executed by a computing device as steps S1 to S9 shown in FIG. 3.

In step S1, a client or service provider provides a service request that includes a plurality of feature labels, which is then inputted to the item selector 20 of the service plan generation system. In an embodiment, the service request also includes a cost requirement specified by the client, such as a total budget of 1 million dollars or a total execution schedule of three months.

In step S2, the item selector 20 selects a plurality of recommended items from a plurality of standardized items stored in the item database 10 according to the plurality of feature labels.

In step S3, the failure rate calculator 30 calculates a plurality of item failure rates according to a plurality of historical execution records of the plurality of recommended items. In an embodiment, after calculating the plurality of item failure rates, the failure rate calculator 30 further compares an overall failure rate threshold with each item failure rate to filter the plurality of recommended items.

In step S4, the failure rate calculator 30 calculates a plurality of redo counts corresponding to the plurality of recommended items according to the plurality of item failure rates. In an embodiment, the failure rate calculator 30 converts each redo count from a floating-point number to an integer according to a quantization threshold.

In step S5, the failure rate calculator 30 generates a plurality of buffer items corresponding to the plurality of recommended items according to the plurality of redo counts. In an embodiment, it is assumed that the plurality of recommended items includes a first item, a second item, and a third item, corresponding to a first redo count, a second redo count, and a third redo count in the plurality of redo counts, respectively. When the first redo count corresponding to the first time is greater than 1, the failure rate calculator 30 generates a corresponding number of first buffer items according to the first redo count as part of the plurality of buffer items. When a sum of the second redo count corresponding to the second item and the third redo count corresponding to the third item is greater than 1, the failure rate calculator 30 generates a corresponding number of combined buffer items according to the sum as another part of the plurality of buffer items.

In step S6, the service scheduler 40 generates a service plan according to the plurality of recommended items and the plurality of buffer items. In an embodiment, after determining the resource consumption (e.g., time, manpower), the service scheduler 40 further calculates a service cost according to a unit price corresponding to each recommended item. In an embodiment, the service plan includes a list of service items, a schedule, a cost estimation, and a confidence level corresponding to this service plan. An additional review checkpoint, as shown in step S7, is required before formal submission to the client.

In step S7, the service provider conducts an internal review of the service plan. If the internal review passes, the service plan is provided to the client as the final version, as shown in step S8. Conversely, if the service plan fails the internal review or if the calculated service cost according to the service plan does not meet the cost requirement specified in the service request, step S9 is performed. In step S9, the service provider manually adjusts the overall failure rate threshold, quantization threshold, or intrinsic failure rates of recommended items, or negotiates with the client to adjust the cost requirement specified in the service request (e.g., raising prices, extending schedules), and then returns to step S1 to re-execute the service plan generation method according to an embodiment of the present disclosure. Adjusting the overall failure rate threshold can be used to filter out lower-risk service items. Adjusting the intrinsic failure rates of recommended items or quantization threshold can increase the number of buffer items in a failure condition, reducing the risk of affecting overall service quality due to the failure of a service item.

In an embodiment, the service plan generation system further includes a pre-processing module and a standardized item module. The method for generating standardized items includes following steps: analyzing a plurality of instances in a plurality of historical execution records to generate a plurality of feature tags; generating a plurality of scores corresponding to the plurality of feature tags as a term frequency vector according to the plurality of instances; and performing an aggregation procedure for a plurality of times, where each time performing the aggregation procedure includes: performing a clustering algorithm to classify a plurality of feature vectors corresponding to the plurality of instances into a plurality of groups, wherein each of the plurality of feature vectors includes the term frequency vector; for each of the plurality of groups, analyzing a part of the plurality of feature vectors to obtain a plurality of variant parts and an identical part; outputting the plurality of variant parts as a feature tag set and using the identical part as an index of the group; and when detecting a stop condition of the aggregation procedure, storing the index generated last time by the aggregation procedure as the standardized item in the item database. Below are detailed descriptions for each step.

The pre-processing module analyzes a plurality of instances of a plurality of historical execution records to generate a plurality of feature tags. In an embodiment, the plurality of feature tags includes text information (such as task description, hardware configuration), time information (such as date, duration, frequency), risk information (such as status of failed or passed, difficulty level), associated items, and so on. In an embodiment, the pre-processing module uses the stemming technique.

Examples of the input (historical execution records) and output (feature labels) of the pre-processing module are shown in Tables 5 and 6 below, respectively. Please refer to Table 5. The historical execution record includes the plurality of instances and their serial numbers. For the sake of brevity, Table 5 only shows the instance name. In an embodiment, in addition to the instance name, an instance may also include a large amount of information such as the production steps of the instance, the time and cost required for each step, the probability of production failure, and the equipment required for production. It should be noted that the instance in the historical execution record may have wrong information, for example, instance 12 is actually the same as instance 1, but the name of instance 12 is misspelled. This situation will be rectified by human in a later step.

Table 5, an example of historical execution records.

| No. | Instance name |
|---|---|
| 1 | banana ice cream |
| 2 | blueberry ice cream |
| 3 | cherry ice cream |
| 4 | chocolate pound cake |
| 5 | banana pound cake |
| 6 | pikachu birthday cake |
| 7 | chocolate birthday cake |
| 8 | strawberry birthday cake |
| 9 | chocolate milkshake |
| 10 | strawberry milkshake |
| 11 | banana milkshake |
| 12 | bannana ice cream |
| . . . | . . . |

Table 6, an example of feature tag.

| ID | Feature tag |
|---|---|
| 1 | banana |
| 2 | birthday |
| 3 | blueberry |
| 4 | cake |
| 5 | cherry |
| 6 | chocolate |
| 7 | cream |
| 8 | ice |
| 9 | lemon |
| 10 | milkshake |
| 11 | pound |
| 12 | strawberry |
| 13 | bannana |
| . . . | . . . |

The standardized item module generates a plurality of scores corresponding the plurality of feature tags according to the plurality of instances to serve as a term frequency vector. In an embodiment, the score is calculated by a term frequency (TF) and/or a term frequency-inverse document frequency (tf-idf). The execution result using TF is shown in Table 7, where the unfilled entry represents a zero value. Please refer to Table 5 and Table 6. The instance “banana ice cream” with No. 1 corresponds feature tags with ID 1, ID 6, and ID 8. Therefore, the term frequency vector of instance No. 1 is [1 0 0 0 0 0 1 1 . . . ] in Table 7. It should be noted that using TF and tf-idf for the same instance will produce different term frequency vectors. The range of values in the term frequency vector may be 0/1 or any real numbers, and this depends on the calculation method of the score. In general, the higher the score is, the more representative the feature tag is.

Table 7, an example of the term frequency vectors.

| | ID | | | | | | | | |
|---|---|---|---|---|---|---|---|---|---|
| No. | 1 | 2 | 3 | 4 | 5 | 6 | 7 | 8 | . . . |
| 1 | 1 | | | | | | 1 | 1 | . . . |
| 2 | | | 1 | | | | 1 | 1 | . . . |
| 3 | | | | | 1 | | 1 | 1 | . . . |
| 4 | | | | 1 | | 1 | | | . . . |
| . . . | . . . | . . . | . . . | . . . | . . . | . . . | . . . | . . . | . . . |
| N | . . . | . . . | . . . | . . . | . . . | . . . | . . . | . . . | . . . |

The standardized item module performs an aggregation procedure for a plurality of times to output one or more feature tag sets and generate a plurality of standardized items. Each time performing the aggregation procedure includes the following steps 1 to 6.

In step 1, the standardized item module performs a clustering algorithm to classify a plurality of feature vectors into a plurality of groups. Each feature vector has a plurality of feature dimensions, which includes the term frequency vector at least. In an embodiment, the feature vector further includes time information, risk information, and other information as shown in the following Table 8. The time information, risk information and other information may be converted into a numerical vector form using a specified conversion mechanism or according to the distribution state. For example: “Friday, Oct. 21, 2022” can be converted to a 19-dimensional vector of [0000100, 000000000100]. The conversion mechanism for this vector is as follows: The left seven values correspond to Monday through Sunday (since the example is Friday, the fifth value from the left is 1, and the rest are 0), and the right twelve values correspond to January through December (since the example is October, the third value from the right is 1, and the rest are 0).

Table 8, an example of the feature vector.

| | Feature vector | | | |
|---|---|---|---|---|
| No. | Term frequency vector | Time Info. | Risk Info. | Other Info. |
| 1 | | | | |
| 2 | | | | |
| 3 | | | | |
| 4 | | | | |
| . . . | | | | |

In an embodiment, the clustering algorithm is hierarchical clustering. Table 9 is a grouping example of the execution result of step A50. For the sake of simplicity, only the term frequency vector of the feature vector is presented, and the value in the vector is replaced by the instance name to be easily understood.

Table 9, a grouping example of feature vectors.

| | Feature vector | | |
|---|---|---|---|
| No. | Variant part | Identical part | Group ID |
| 1 | banana | ice cream | 1 |
| 2 | blueberry | ice cream | |
| 3 | cherry | ice cream | |
| 12 | bannana | ice cream | |
| 4 | chocolate | pound cake | 2 |
| 5 | banana | pound cake | |
| 6 | pikachu | birthday cake | 3 |
| 7 | chocolate | birthday cake | |
| 8 | strawberry | birthday cake | |
| 9 | chocolate | milkshake | 4 |
| 10 | strawberry | milkshake | |
| 11 | banana | milkshake | |
| . . . | . . . | . . . | . . . |

In step 2, the standardized item module extracts a plurality of feature vectors in a group, and analyzes a plurality of variant parts and an identical part of these feature vectors. Taking the example in Table 9, the four feature vectors (corresponding to instances 1, 2, 3, and 12 respectively) of group 1 are extracted first. In an embodiment, the standardized item module adopts Natural Language Processing (NLP) technology in artificial intelligence to analyze the same dimension (ice cream) in these feature vectors as the identical part, and different dimensions (banana, blueberry, cherry, banana) in these feature vectors as the plurality of variant parts.

In step 3, the standardized item module outputs the variant parts as feature tag sets, and uses the identical part as an index of the group. Continuing from the above example, the feature tag set outputted first includes four tags, “banana, blueberry, cherry, banana”. The index of group 1 is “ice cream”. The index makes it easy to understand the attribute of the group. In an embodiment, the longest identical phrase in the identical part may be used as a group name that is easily recognizable by humans. If the text part is missing, it can be named manually. In an embodiment, the system administrator reviews each feature tag output by the system, and removes or corrects wrong tags, such as removing the tag “banana” or correcting it to “banana”.

In step 4, the standardized item module determines whether analyses of all groups are completed. If the determination is “yes”, step A56 will be performed. If the determination is “no”, the next step will be step 1 for selecting another group to repeat the process of steps 2 to 4.

In step 5, the standardized item module determines whether to detect a stop condition of the aggregation procedure. If the determination is “yes”, step 6 will be performed. If the determination is “no”, the next step will be step 1 for regrouping the current groups. Each regrouping may reduce the number of groups. In an embodiment, the stop condition is that the number of groups is less than a threshold, such as 100 groups or the similarity between groups is less than another threshold such as 0.6. Similarity can be calculated using metrics such as the Jaccard similarity coefficient or cosine similarity.

In step 6, the standardized item module stores the index generated by the aggregation procedure last time as the standardized item in the item database 10. For example, regarding group 2 (pound cake) and group 3 (birthday cake) in Table 9, these instances in group 2 and group 3 may be classified into the same large group after executing the aggregation procedure multiple times, and may use “cake” as the standardized item.

It should be noted that common NLP only focuses on the analysis of the identical part, so after the identical part is obtained, the original feature vector is no longer processed. On the other hand, the present disclosure not only extracts the identical part in the feature vector, but also extracts the variant part as the feature tag set to output. The present disclosure is different from common NLP. The present disclosure regroups the feature vector multiple times to output the feature tag set in each grouping process, and output standardized item according to the final grouping result.

In view of the above, the present disclosure introduces a service plan generation system and method for automatically generating service plan quotations, minimizing human intervention, thus saving time and costs. The service plan quotation includes a list of work items, a schedule of service item execution, and cost estimations. Clients send requests containing project information or criteria through terminal devices, and the system reviews historical execution records to provide a recommended list of service items, estimates the item execution duration, and considers the risk of failure. Subsequently, schedules and cost estimations can be generated and sent back to the client's device. The advantages of the present disclosure are as follows. First, time-saving, the above process is not only digitized but also automated, saving time and increasing service flexibility. Second, transparent and adjustable cost estimation, cost components can be tracked from the itemized historical execution records, and it can also display the service confidence level for this plan. For business negotiations, the proposed costs can still be adjusted to fit the client's budget, and the selected service confidence level can reflect the risk of this plan.

Although embodiments of the present application are disclosed as described above, they are not intended to limit the present application, and a person having ordinary skill in the art, without departing from the spirit and scope of the present application, can make some changes in the shape, structure, feature and spirit described in the scope of the present application. Therefore, the scope of the present application shall be determined by the scope of the claims.

What is claimed is:

1. A service plan generation method performed by a computing device comprising:
receiving a service request, wherein the service request includes a plurality of feature labels;
selecting a plurality of recommended items from an item database according to the plurality of feature labels;
calculating a plurality of item failure rates according to a plurality of historical execution records of the plurality of recommended items;
calculating a plurality of redo counts corresponding to the plurality of recommended items according to the plurality of item failure rates;
generating a plurality of buffer items corresponding to the plurality of recommended items according to the plurality of redo counts; and
performing a scheduling according to the plurality of recommended items and the plurality of buffer items to generate a service plan.

2. The service plan generation method of claim 1, wherein generating the plurality of buffer items corresponding to the plurality of recommended items according to the plurality of redo counts comprises:
generating a corresponding number of first buffer items as part of the plurality of buffer items when a first redo count of a first item is greater than 1; and
generating a corresponding number of combined buffer items as part of the plurality of buffer items when a sum of a second redo count of a second item and a third redo count of a third item is greater than 1;
wherein the first item, the second item, and the third item are three of the plurality of recommended items, and the first redo count, the second redo count, and the third redo count are three of the plurality of redo counts.

3. The service plan generation method of claim 1, further comprising:
after calculating the plurality of item failure rates according to the plurality of historical execution records of the plurality of recommended items, comparing an overall failure rate threshold with each of the plurality of item failure rates to filter the plurality of recommended items.

4. The service plan generation method of claim 1, wherein calculating the plurality of redo counts corresponding to the plurality of recommended items according to the plurality of item failure rates comprises:
converting the plurality of redo counts from floating-point numbers to integers according to a quantization threshold.

5. The service plan generation method of claim 4, further comprising:
calculating a service cost according to the service plan; and
when the service cost does not meet a cost requirement of the service request, modifying the quantization threshold and performing the service plan generation method of claim 1 again.

6. A service plan generation system comprising:
an item database configured to store a plurality of standardized items;
an item selector configured to select a plurality of recommended items from the plurality of standardized items of the item database according to a plurality of feature labels included in a service request; and
a failure rate calculator configured to calculate a plurality of item failure rates according to a plurality of historical execution records of the plurality of recommended items, calculate a plurality of redo counts corresponding to the plurality of recommended items according to the plurality of item failure rates, and generate a plurality of buffer items corresponding to the plurality of recommended items according to the plurality of redo counts; and
a service scheduler configured to perform a scheduling according to the plurality of recommended items and the plurality of buffer items to generate a service plan.

7. The service plan generation system of claim 6, wherein generating the plurality of buffer items corresponding to the plurality of recommended items according to the plurality of redo counts by the failure rate calculator comprising:
generating a corresponding number of first buffer items as part of the plurality of buffer items when a first redo count of a first item is greater than 1; and
generating a corresponding number of combined buffer items as part of the plurality of buffer items when a sum of a second redo count of a second item and a third redo count of a third item is greater than 1;
wherein the first item, the second item, and the third item are three of the plurality of recommended items, and the first redo count, the second redo count, and the third redo count are three of the plurality of redo counts.

8. The service plan generation system of claim 6, wherein the failure rate calculator is further configured to compare an overall failure rate threshold with each of the plurality of item failure rates to filter the plurality of recommended items after calculating the plurality of item failure rates according to the plurality of historical execution records of the plurality of recommended items.

9. The service plan generation system of claim 6, wherein calculating the plurality of redo counts corresponding to the plurality of recommended items according to the plurality of item failure rates by the failure rate calculator comprises:
converting the plurality of redo counts from floating-point numbers to integers according to a quantization threshold.

10. The service plan generation system of claim 9, wherein the service scheduler is further configured to calculate a service cost according to the service plan, and when the service cost does not meet a cost requirement of the service request, the service plan generation system is further configured to modify the quantization threshold and operate again.
